(19) United States
(12) Patent Application Publication
(10) Pub. No.: US 2020/0402153 A1
(43) Pub. Date: Dec. 24, 2020

(54) NEGOTIATION DEVICE

(71) Applicant: Wells Fargo Bank, N.A., San Francisco, CA (US)

(72) Inventors: Wendy Sue Minkus, Phoenix, AZ (US); Margaret Ritchie Duguid, Scottsdale, AZ (US); Chris Theodore Kalaboukis, San Jose, CA (US); Janet Elaine McClellan, Gilbert, AZ (US); Robert Ronnau, Mesa, AZ (US); Donald Jeffrey Winans, Tempe, AZ (US)

(21) Appl. No.: 15/811,147

(22) Filed: Nov. 13, 2017

(51) Int. Cl. G06Q 40/02; G06Q 50/18; G10L 15/22

(52) U.S. Cl. CPC G06Q 40/02; G06Q 50/188; G10L 15/30; G06Q 40/025; G10L 2015/223; G10L 15/22

(57) ABSTRACT

This disclosure describes techniques for using a computing device to occasionally, periodically, and/or continuously negotiate terms of financial agreements, such as those relating to a financial product or service offered by a bank or other financial institution. In one example, this disclosure describes a method that includes receiving a first indication of audio input associated with a user; generating, based on account information associated with the user, a proposal relating to a financial product, wherein the proposal includes a request for information; sending, over the network, information about the proposal; responsive to sending the information about the proposal, receiving, the network, a second indication of audio input including offered information responsive to the request for information; storing the offered information; and adjusting the account information associated with the user to reflect acceptance of the proposal.

### TECHNICAL FIELD

This disclosure relates to communicating information over a computer network, and more specifically, to communicating with a computing device about terms of an agreement to provide a product or service.

### BACKGROUND

Banks and other financial institutions routinely provide financial services to consumers, which encompass services ranging from managing money, providing banking services, lending money, extending credit, and/or providing advice, information, and other services. In some cases, those services are provided pursuant to a well-defined fee structure. In other cases, the terms of the service can be negotiated. In many cases, however, consumers do not know to what extent certain services are negotiable, or even whether such services are subject to negotiation. Further, financial institutions often adjust the price or terms of some services based on certain attributes of the consumer, such as a credit rating. However, beyond a credit rating and other basic information, financial institutions may lack significant information about their customers.

### SUMMARY

This disclosure describes techniques for using a computing device to occasionally, periodically, and/or continuously negotiate terms of financial agreements, such as those relating to a financial product or service offered by a bank or other financial institution. Techniques in accordance with one or more aspects of the present disclosure may enable a user (e.g., a customer of a bank) to obtain favorable terms of a financial agreement without significant efforts and tedious communications with bank personnel. Similarly, such techniques may enable a bank to collect information about users (e.g., customers of the bank) that can be used not only to provide improved service to its customers, but also to identify financial products and services that may be particularly suited or appropriate for a given user.

As described in one or more examples, a computing system operated by a bank may receive data corresponding to audio detected by an audio chat device located near a user, such as in a user's home. The computing system may analyze the data and respond with information that can be used by the audio chat device to generate audible sounds that mimic a human voice. In some examples, the computing system continually analyzes audio data streamed from the audio chat device and responds appropriately with audible sounds to thereby engage in an interactive discussion with the user. Such a discussion may include a discussion or negotiation of existing or proposed terms of financial products or services provided by the bank. Such a discussion may also include offers relating to new financial products or services that the computing system markets to the user.

In one example, this disclosure describes a method comprising receiving, by a computing system and over a network, a first indication of audio input associated with a user; generating, by the computing system and based on account information associated with the user, a proposal relating to a financial product, wherein the proposal includes a request for information; sending, by the computing system and over the network, information about the proposal; responsive to sending the information about the proposal, receiving, by the computing system and over the network, a second indication of audio input including offered information responsive to the request for information; storing, by the computing system, the offered information; and adjusting, by the computing system, the account information associated with the user to reflect acceptance of the proposal.

In another example, this disclosure describes a system comprising a storage device; and processing circuitry having access to the storage device and configured to: receive, over a network, a first indication of audio input associated with a user, generate, based on account information associated with the user, a proposal relating to a financial product, wherein the proposal includes a request for information, send, over the network, information about the proposal, responsive to sending the information about the proposal, receive, over the network, a second indication of audio input including offered information responsive to the request for information, store the offered information, and adjust the account information associated with the user to reflect acceptance of the proposal.

In another example, this disclosure describes a computer-readable storage medium comprises instructions that, when executed, configure processing circuitry of a computing system to receive, over a network, a first indication of audio input associated with a user; generate, based on account information associated with the user, a proposal relating to a financial product, wherein the proposal includes a request for information; send, over the network, information about the proposal; responsive to sending the information about the proposal, receive, over the network, a second indication of audio input including offered information responsive to the request for information; store the offered information; and adjust the account information associated with the user to reflect acceptance of the proposal.

### BRIEF DESCRIPTION OF THE DRAWINGS

FIG. 1 is a conceptual diagram illustrating an example system which enables a financial institution to engage in occasional, periodic, or continuous negotiation of the terms of financial services with a user and/or marketing of financial services to a user, in accordance with one or more aspects of the present disclosure.

FIG. 2 is a block diagram illustrating an example system which enables a financial institution to engage in occasional, periodic, or continuous negotiation of the terms of financial services with a user and/or marketing of financial services to a user, in accordance with one or more aspects of the present disclosure.

FIG. 3A, FIG. 3B, FIG. 3C, FIG. 3D, and FIG. 3E are conceptual diagrams illustrating the operation of an example bank computing system responding to a user's proposal detected by an example audio chat device, in accordance with one or more aspects of the present disclosure.

FIG. 4A, FIG. 4B, FIG. 4C, and FIG. 4D are conceptual diagrams illustrating the operation of an example bank computing system responding to a user's question detected by an example audio chat device, in accordance with one or more aspects of the present disclosure.

FIG. 5A and FIG. 5B are conceptual diagrams illustrating the operation of an example bank computing system initiating a negotiation with a user of an example audio chat device, in accordance with one or more aspects of the present disclosure.

FIG. 6 is a flow diagram illustrating operations performed by an example bank computing system in accordance with one or more aspects of the present disclosure.

### DETAILED DESCRIPTION

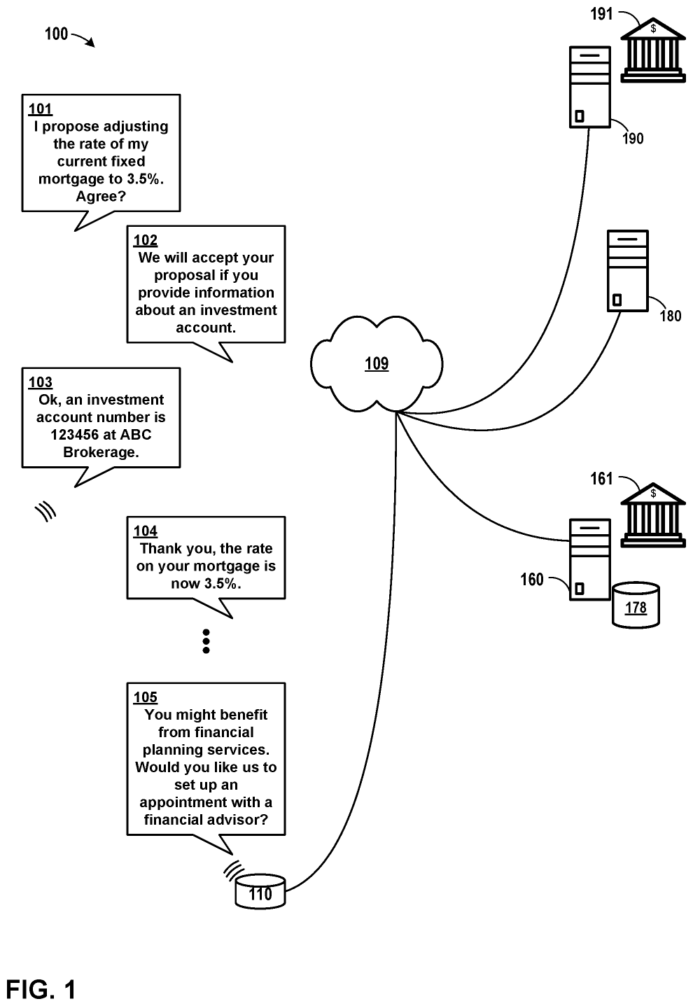

FIG. 1 is a conceptual diagram illustrating an example system 100 that enables a financial institution to engage in occasional, periodic, or continuous negotiation of the terms of financial services with a user and/or marketing of financial services to a user, in accordance with one or more aspects of the present disclosure. System 100 includes audio chat device 110, bank computing system 160, information service computing system 180, and brokerage computing system 190 connected to each other via network 109. Bank computing system 160 may include or be connected to user account data store 178. Represented in FIG. 1 are a number of entities, including bank 161 and brokerage 191. Bank computing system 160 is owned, controlled, and/or operated by bank 161. User account data store 178 may include records associated with account holders at bank 161. Brokerage computing system 190 is owned, controlled, and/or operated by brokerage 191.

Audio chat device 110 may be implemented as a voice activated computing device primarily in communication with bank computing system 160 over network 109, and controlled by bank computing system 160. Audio chat device 110 may, in some examples, interface with users primarily by recognizing audible commands from a user through voice recognition and presenting information to users through computer-generated sounds, including those designed to mimic a human voice. In other examples, audio chat device 110 may accept other types of input and generate other types of output. For instance, audio chat device 110 may accept wireless input from a tablet device within the vicinity of audio chat device 110, or through a computing device connected to audio chat device 110 over network 109. Audio chat device 110 may also generate output for display at a display screen, or may output control signals destined for other computing devices. Other examples are possible.

In some examples, audio chat device 110 may be a device configured for use for a specific user by bank 161, and delivered to the home of that specific user by bank 161. In such an example, audio chat device 110 may be configured with a particular address or unique code that can be identified in later communications with bank computing system 160. In other examples, audio chat device 110 may be a generic device that requires configuration for use in connection with accounts held at bank 161 or another bank. Once identified by bank computing system 160, audio chat device 110 may be associated with a particular user, or group of users, and communications between audio chat device 110 and bank computing system 160 may be based on, or may apply to, accounts held by that particular user or group of users at bank 161.

In the example of FIG. 1, and in accordance with one or more aspects of the present disclosure, bank computing system 160 may associate audio chat device 110 with a preexisting account at bank 161. For instance, in the example of FIG. 1, when audio chat device 110 is initially connected to network 109, audio chat device 110 outputs a signal over network 109. Bank computing system 160 detects a signal and identifies, based on information included within the signal, audio chat device 110. In some examples, bank computing system 160 is able to associate one or more accounts at bank 161 with audio chat device 110 based on an identifying code or other information included within a communication received from audio chat device 110.

In other examples, bank computing system 160 associates one or more accounts with audio chat device 110 based on authentication information detected at audio chat device 110, communicated over network 109, and received at bank computing system 160. For instance, in such an example, bank computing system 160 outputs a signal over network 109. Audio chat device 110 detects a signal over network 109, and determines that the signal corresponds to a command to prompt a user of audio chat device 110 for authentication credentials. Audio chat device 110 outputs an audible prompt for information (e.g., asking a user to state his or her name, bank account number, address, and/or password). Audio chat device 110 detects a response, and communicates information about the response over network 109 to bank computing system 160. Bank computing system 160 may, based on the information, authenticate a user of audio chat device 110 and thereafter associate communications received from audio chat device 110 with one or more bank accounts held by the authenticated user of audio chat device 110.

Bank computing system 160 may determine that a user of audio chat device 110 has proposed adjusting the terms of a financial services arrangement that the user holds with bank 161. For instance, in the example of FIG. 1, audio chat device 110 detects audio input and outputs a signal over network 109. Bank computing system 160 detects a signal over network 109 and determines that the signal corresponds to audible input from the user associated with audio chat device 110. Bank computing system 160 further determines that the signal corresponds to a financial services proposal by the user associated with audio chat device 110. For example, bank computing system 160 may determine that the user has proposed to refinance his or her home mortgage for a fixed 30-year term at 3.5%, as illustrated in FIG. 1 as box 101. In other words, bank computing system 160 may determine that while the user was near audio chat device 110, he or she said “I propose adjusting the rate of my current fixed mortgage to 3.5%.” In another example, bank computing system 160 may determine that the user has proposed increasing a line of credit by a specific amount (e.g., by an additional $10,000). In yet another example, bank computing system 160 may determine that the user has proposed issuing a new credit card to a family member. Any number of additional or alternative proposals or requests may be detected by audio chat device 110 and processed by bank computing system 160, including, without limitation, any proposal or request that might be made by that same user visiting a branch associated with bank 161, placing a call to bank 161, or by interacting online with bank 161.

Bank computing system 160 may, in some examples, accept the user's proposal. For instance, in some examples, bank computing system 160 accesses information (e.g., credit and account history) within user account data store 178 about the user of audio chat device 110. Bank computing system 160 determines, based on the accessed information, whether to accept the user's proposed terms. In some examples, bank computing system 160 determines that bank 161 will accept the user's proposal. In such an example, bank computing system 160 outputs a signal over network 109. Audio chat device 110 detects a signal over network 109, and determines that the signal corresponds to audio information. Audio chat device 110 outputs audible information, informing the user that bank 161 has accepted the proposal. In other examples, of course, bank computing system 160 might not accept the user's proposal, and in that case, audio chat device 110 may output audible information informing the user that bank 161 has not accepted the proposal.

In the example of FIG. 1, however, rather than simply accepting or denying the user's proposal, bank computing system 160 generates a counterproposal and presents it to the user of audio chat device 110. For instance, in the example of FIG. 1, bank computing system 160 outputs a signal over network 109. Audio chat device 110 detects a signal, and determines that the signal includes audio information. Audio chat device 110 outputs audio information, informing the user of the counterproposal. In the example of FIG. 1, the counterproposal is a conditional acceptance of the user's proposal, conditioned on the user providing additional information. For instance, the counterproposal may correspond to that illustrated in box 102: “We will accept your proposal if you provide information about an investment account.” Bank 161 may have a business interest in information about the user's investment accounts because that information may help bank 161 assess the user's candidacy for other financial products and services. Further, the information may be useful to help bank 161 assessing the risk it is accepting by refinancing the user's loan. Accordingly, the information that bank 161 seeks has value to bank 161.

In the example illustrated in FIG. 1, the counterproposal may be based on the user's proposal as well as other information available to bank computing system 160, such as credit and account history for the user. For instance, in some examples, bank computing system 160 may output a signal over network 109. Information service computing system 180 may detect a signal over network 109 and determine that the signal includes a request for information about a user of audio chat device 110. Information service computing system 180 may access information about such a user, and output a signal over network 109. Bank computing system 160 may detect a signal over network 109 and determine that the signal includes the requested information about the user of audio chat device 110. Bank computing system 160 may further determine that the information corresponds to demographic information, credit and account history information, publicly-available information, information available through a private reporting service, or other information. Bank computing system 160 may generate the counterproposal based on some or all of such information received from information service computing system 180 or from another service accessible through network 109.

Bank computing system 160 may determine that the user of audio chat device 110 has accepted the counterproposal. For instance, in the example of FIG. 1, audio chat device 110 detects audio input, and outputs a signal over network 109. Bank computing system 160 detects a signal over network 109 and determines that the signal corresponds to the user's acceptance of the counterproposal. Bank computing system 160 further determines that the signal includes information corresponding to the requested information about the user's investment accounts. For example, bank computing system 160 may determine that the signal includes access credentials (e.g., read-only access credentials) for an account at brokerage 191. In some examples, the access credentials might only be valid and usable by bank computing system 160 and/or bank 161 for a limited time (e.g., on the order of months). In other examples, the access credentials might be valid and usable by bank computing system 160 and/or bank 161 indefinitely. Bank computing system 160 stores, in user account data store 178, data about the information the user has offered about his or her investment accounts (“offered information”). Further, bank computing system 160 updates the account and other records stored in user account data store 178 associated with the user in accordance with the new terms of the mortgage.

Bank computing system 160 may, based on the offered information, market additional financial products and/or services. For instance, in the example of FIG. 1, and some time after the user's proposal to refinance his or her mortgage (e.g., days, weeks, months, years), bank computing system 160 accesses information about the user of audio chat device 110 in user account data store 178. In some examples, the accessed information may include some or all of the offered information about the user of audio chat device 110. Bank computing system 160 generates, based on the accessed information, a new proposal for the user of audio chat device 110 relating to a financial product or service that may of interest to the user, or may be appropriate or applicable to the user. Bank computing system 160 outputs a signal over network 109. Audio chat device 110 detects a signal over network 109, and determines that the signal includes audio information. Audio chat device 110 outputs audio information about the new proposal. In response, audio chat device 110 detects audio input and outputs a signal over network 109. Bank computing system 160 detects a signal over network 109 and determines that the signal indicates that audio chat device 110 detected audio input from the user that corresponds to acceptance of the new proposal. Bank computing system 160 updates the account and other records associated with the user to reflect the user's acceptance of the new proposal. Thereafter, bank computing system 160 further updates the user's account as appropriate during the course of providing services, pursuant to the new proposal, to the user of audio chat device 110.

FIG. 1 illustrates one example implementation of system 100. Other example or alternative implementations of system 100 may be appropriate in other instances. For instance, in the example illustrated in FIG. 1, to process input by a user, audio chat device 110 detects audio input and outputs a signal over network 109 for analysis by bank computing system 160. Similarly, to cause audio chat device 110 to generate audible sounds, bank computing system 160 outputs a signal over network 109 that includes audio information that audio chat device 110 outputs as a sound. In such examples, much of the processing of audio information is performed by bank computing system 160, rather than by audio chat device 110. In other examples, however, audio chat device 110 may perform significant processing of audio input detected by audio chat device 110, rather than relying on bank computing system 160 to perform such processing. Further, in other examples, audio chat device 110 may receive information from bank computing system 160 that requires significant audio processing before it can be used to generate audible sounds. Also, although examples are described herein in terms of financial products and services, techniques described herein may apply to other types of products and services, and this disclosure is not necessarily limited to financial products and services.

Accordingly, although one or more implementations of system 100 have been described with reference to FIG. 1, system 100 may be implemented in a number of different ways. For instance, one or more devices of system 100 that may be illustrated as separate devices may alternatively be implemented as a single device; one or more components of system 100 that may be illustrated as separate components may alternatively be implemented as a single component. Also, in some examples, one or more devices of system 100 that may be illustrated as a single device may alternatively be implemented as multiple devices; one or more components of system 100 that may be illustrated as a single component may alternatively be implemented as multiple components. Each of the multiple devices and/or components may be directly coupled via wired or wireless communication and/or remotely coupled via one or more networks. Also, one or more devices or components that may be illustrated in FIG. 1 may alternatively be implemented as part of another device or component not shown in FIG. 1.

Further, certain operations, techniques, features, and/or functions may have been described herein as being performed by specific components, devices, and/or modules in FIG. 1. In other examples, such operations, techniques, features, and/or functions may be performed by different components, devices, or modules. Accordingly, some operations, techniques, features, and/or functions that may have been described herein as being attributed to one or more components, devices, or modules in FIG. 1 may, in other examples, be attributed to other components, devices, and/or modules, even if not specifically described herein in such a manner.

In accordance with one or more aspects of this disclosure, one or more computing devices (e.g., audio chat device 110 or bank computing system 160) may analyze information collected from a user by another computing device (e.g., streamed or recorded conversations and voice input detected by audio chat device 110). It may be appropriate for such computing devices to collect, analyze, and/or act on such information in the manner described herein only after receiving permission from the user. For example, in some examples described in this specification, before a computing device can collect or make use of information associated with a user, the user may be provided with an opportunity to control whether the computing device can collect or make use of information about the user (e.g., use of recorded conversations for marketing purposes), or to dictate whether and/or how the computing device can use such information. In some examples, certain data may be modified so that personally-identifiable information is removed. In other examples, a user's information may be anonymized in some way (e.g., by associating the data only with categories of bank accounts, or categories of bank customers, or by generalizing the information so that it is associated with a city, ZIP code, or state so that the identify or location of a user cannot be determined.)

Through techniques in accordance with one or more aspects of the present disclosure, such as by allowing users to occasionally, periodically, and/or continuously negotiate the terms of financial products and services using audio chat device 110, system 100 may more often present or enable a user to determine appropriate terms of financial products and services in an efficient manner. By doing so, system 100 may reduce the likelihood that a user will have to perform research to identify or determine favorable terms for financial products and services. By enabling a user to avoid performing such research, system 100 will perform fewer computing operations and consume less network bandwidth, because performing such research requires computing operations and network bandwidth. Therefore, aspects of this disclosure may improve the function of system 100 because allowing users to occasionally, periodically, and/or continuously negotiate the terms of financial products and services may have the effect of causing system 100 to perform fewer computing operations and consume less network bandwidth.

Through techniques in accordance with one or more aspects of the present disclosure, such as by enabling bank computing system 160 to occasionally, periodically, and/or continuously market financial products and services to users based on information collected from users, system 100 may more efficiently identify financial products and services that benefit users. By more efficiently identifying financial products and services that benefit users, system 100 may perform fewer computing operations and consume less network bandwidth because other ways of identifying and/or marketing financial products and services are less efficient and effective, and to achieve similarly productive results, may require significant consumption of computing resources and network bandwidth. Therefore, aspects of this disclosure may improve the function of system 100 because enabling bank computing system 160 to occasionally, periodically, and/or continuously market financial products and services to users based on information collected from users may have the effect of causing system 100 to perform fewer computing operations and consume less network bandwidth.

Further, by performing fewer computing operations and consuming less network bandwidth, system 100 may consume less electrical power because performing computing operations and consuming network bandwidth consumes electrical power. Therefore, aspects of this disclosure may improve the function of system 100 because enabling bank computing system 160 to occasionally, periodically, and/or continuously market financial products and services to users based on information collected from users may have the effect of causing system 100 to consume less electrical power.

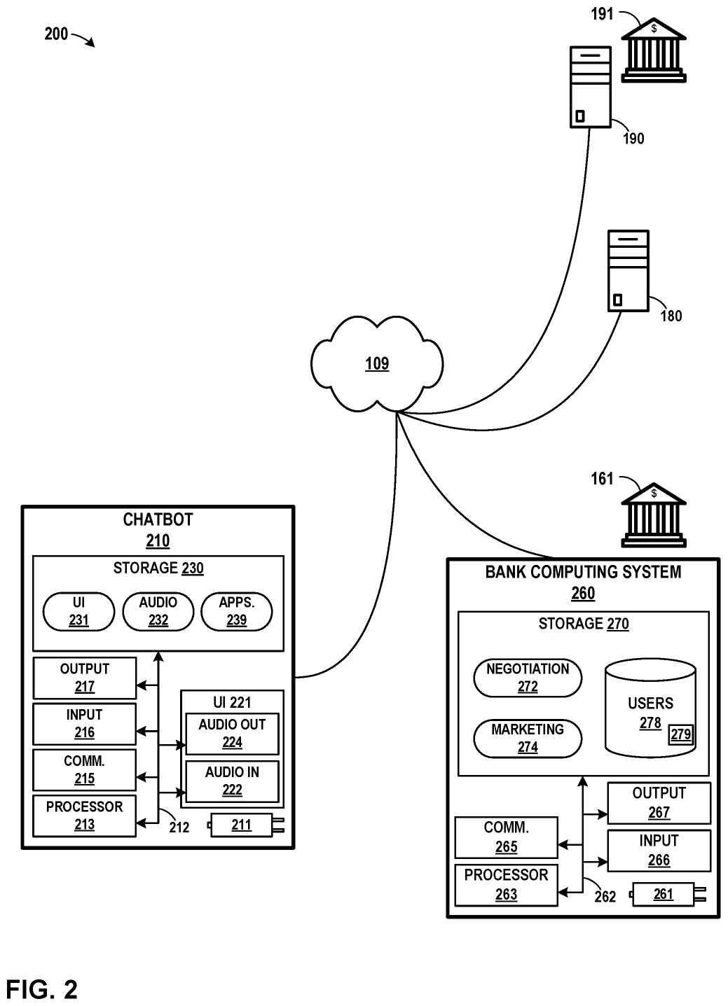

FIG. 2 is a block diagram illustrating an example system which enables a financial institution to engage in occasional, periodic, or continuous negotiation of the terms of financial services with a user and/or marketing of financial services to a user, in accordance with one or more aspects of the present disclosure. System 200 of FIG. 2 may be described as an example or alternative implementation of system 100 of FIG. 1. One or more aspects of FIG. 2 may be described herein within the context of FIG. 1.

In the example of FIG. 2, system 200 includes network 109, audio chat device 210, bank computing system 260, information service computing system 180, and brokerage computing system 190. In FIG. 2, network 109 may correspond to network 109 of FIG. 1, information service computing system 180 may correspond to information service computing system 180 of FIG. 1, and brokerage computing system 190 may correspond to brokerage computing system 190 of FIG. 1. Although only one information service computing system 180 and one brokerage computing system 190 are shown, many more could be included. Also, audio chat device 210 may correspond to audio chat device 110 of FIG. 1. Bank computing system 260 may generally correspond to a system that combines, includes, and/or implements aspects of the functionality of bank computing system 160 and user account data store 178 of FIG. 1. For ease of illustration, only one audio chat device 210 and one bank computing system 260 is illustrated in FIG. 2, although techniques in accordance with one or more aspects of the present disclosure may be performed with many more of such systems.

Network 109 may be the internet, or may include or represent any public or private communications network or other network. For instance, network 109 may be a cellular, Wi-Fi®, ZigBee, Bluetooth, Near-Field Communication (NFC), satellite, enterprise, service provider, and/or other type of network enabling transfer of transmitting data between computing systems, servers, and computing devices. One or more of client devices, server devices, or other devices may transmit and receive data, commands, control signals, and/or other information across network 109 using any suitable communication techniques. Network 109 may include one or more network hubs, network switches, network routers, satellite dishes, or any other network equipment. Such devices or components may be operatively inter-coupled, thereby providing for the exchange of information between computers, devices, or other components (e.g., between one or more client devices or systems and one or more server devices or systems). Each of the devices or systems illustrated in FIG. 2 may be operatively coupled to network 109 using one or more network links. The links coupling such devices or systems to network 109 may be Ethernet, Asynchronous Transfer Mode (ATM) or other types of network connections, and such connections may be wireless and/or wired connections. One or more of the devices or systems illustrated in FIG. 2 or otherwise on network 109 may be in a remote location relative to one or more other illustrated devices or systems.

Each of information service computing system 180, brokerage computing system 190, and bank computing system 260 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, information service computing system 180, brokerage computing system 190, and/or bank computing system 260 may each represent a cloud computing system, server farm, and/or server cluster (or portion thereof) that provides services to client devices and other devices or systems. In other examples, information service computing system 180, brokerage computing system 190, and/or bank computing system 260 may represent or be implemented through one or more virtualized compute instances (e.g., virtual machines, containers) of a data center, cloud computing system, server farm, and/or server cluster.

In the example of FIG. 2, bank computing system 260 may include power source 261, one or more processors 263, one or more communication units 265, one or more input devices 266, one or more output devices 267, and one or more storage devices 270. Storage devices 270 may include negotiation module 272, marketing module 274, and user account data store 278. One or more of the devices, modules, storage areas, or other components of bank computing system 260 may be interconnected to enable inter-component communications (physically, communicatively, and/or operatively). In some examples, such connectivity may be provided by through communication channels (e.g., communication channels 262), a system bus, a network connection, an inter-process communication data structure, or any other method for communicating data.

Power source 261 may provide power to one or more components of bank computing system 260. Power source 261 may receive power from the primary alternating current (AC) power supply in a building, home, or other location. In other examples, power source 261 may be a battery or a device that supplies direct current (DC). In still further examples, bank computing system 260 and/or power source 261 may receive power from another source. One or more of the devices or components illustrated within bank computing system 260 may be connected to power source 261, and/or may receive power from power source 261. Power source 261 may have intelligent power management or consumption capabilities, and such features may be controlled, accessed, or adjusted by one or more modules of bank computing system 260 and/or by one or more processors 263 to intelligently consume, allocate, supply, or otherwise manage power.

One or more processors 263 of bank computing system 260 may implement functionality and/or execute instructions associated with bank computing system 260 or associated with one or more modules illustrated herein and/or described below. One or more processors 263 may be, may be part of, and/or may include processing circuitry that performs operations in accordance with one or more aspects of the present disclosure. Examples of processors 263 include microprocessors, application processors, display controllers, auxiliary processors, one or more sensor hubs, and any other hardware configured to function as a processor, a processing unit, or a processing device. Bank computing system 260 may use one or more processors 263 to perform operations in accordance with one or more aspects of the present disclosure using software, hardware, firmware, or a mixture of hardware, software, and firmware residing in and/or executing at bank computing system 260.

One or more communication units 265 of bank computing system 260 may communicate with devices external to bank computing system 260 by transmitting and/or receiving data, and may operate, in some respects, as both an input device and an output device. In some examples, communication units 265 may communicate with other devices over a network. In other examples, communication units 265 may send and/or receive radio signals on a radio network such as a cellular radio network. In other examples, communication units 265 of bank computing system 260 may transmit and/or receive satellite signals on a satellite network such as a Global Positioning System (GPS) network. Examples of communication units 265 include a network interface card (e.g. such as an Ethernet card), an optical transceiver, a radio frequency transceiver, a GPS receiver, or any other type of device that can send and/or receive information. Other examples of communication units 265 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input devices 266 may represent any input devices of bank computing system 260 not otherwise separately described herein. One or more input devices 266 may generate, receive, and/or process input from any type of device capable of detecting input from a human or machine. For example, one or more input devices 266 may generate, receive, and/or process input in the form of electrical, physical, audio, image, and/or visual input (e.g., peripheral device, keyboard, microphone, camera).

One or more output devices 267 may represent any output devices of bank computing system 260 not otherwise separately described herein. One or more output devices 267 may generate, receive, and/or process input from any type of device capable of detecting input from a human or machine. For example, one or more output devices 267 may generate, receive, and/or process output in the form of electrical and/or physical output (e.g., peripheral device, actuator).

One or more storage devices 270 within bank computing system 260 may store information for processing during operation of bank computing system 260. Storage devices 270 may store program instructions and/or data associated with one or more of the modules described in accordance with one or more aspects of this disclosure. One or more processors 263 and one or more storage devices 270 may provide an operating environment or platform for such modules, which may be implemented as software, but may in some examples include any combination of hardware, firmware, and software. One or more processors 263 may execute instructions and one or more storage devices 270 may store instructions and/or data of one or more modules. The combination of processors 263 and storage devices 270 may retrieve, store, and/or execute the instructions and/or data of one or more applications, modules, or software. Processors 263 and/or storage devices 270 may also be operably coupled to one or more other software and/or hardware components, including, but not limited to, one or more of the components of bank computing system 260 and/or one or more devices or systems illustrated as being connected to bank computing system 260.

In some examples, one or more storage devices 270 are temporary memories, meaning that a primary purpose of the one or more storage devices is not long-term storage. Storage devices 270 of bank computing system 260 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 270, in some examples, also include one or more computer-readable storage media. Storage devices 270 may be configured to store larger amounts of information than volatile memory. Storage devices 270 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories.

Negotiation module 272 may perform functions relating to proposing, negotiating, and/or renegotiating the terms of financial service agreements, financial products, and financial services with one or more users of audio chat devices 210. Negotiation module 272 may employ artificial intelligence and/or machine learning techniques to generate audio signals or an audio data stream that can be output as an audible sound, and thereby mimic a responsive human engaging in an interactive conversation. Negotiation module 272 may also employ response techniques drawing on preprogrammed answers to common questions or preprogrammed conversations to walk a use through various steps to perform a common task. For instance, in some examples, negotiation module 272 may evaluate and/or analyze indications of audio input and interpret the audio input. Negotiation module 272 may evaluate a user proposal, and determine whether the terms of the proposal are acceptable by bank 161. Negotiation module 272 may access information over network 109, including information provided by one or more information service computing systems 180 and one or more brokerage computing systems 190. Negotiation module 272 may generate proposals, counterproposals, and/or conditional proposals. Negotiation module 272 may communicate information about such proposals, counterproposals, and/or conditional counterproposals to one or more audio chat devices 210. Negotiation module 272 may perform actions on behalf of a user, such as opening accounts, scheduling appointments with financial service personnel, engaging financial or other services from a third party, or modifying terms of service for a financial product or service. Negotiation module 272 may receive, evaluate, and store offered information 279. Negotiation module 272 may update and/or maintain user account data store 278 with information about communications with a user of audio chat device 210 and/or information about agreements made or not made between bank 161 and a user of audio chat device 210. Negotiation module 272 may also update information in user account data store 278 to reflect that a proposal was received from the user and subsequently denied. Negotiation module 272 may receive information from and output information to one or more other modules. Although negotiation module 272 may be described in connection with FIG. 2 as primarily performing operations connected to negotiating financial services, negotiation module 272 may alternatively, or in addition, perform financial services, or negotiate the terms of other services. Negotiation module 272 may interact with and/or operate in conjunction with one or more modules of bank computing system 260. Functions performed by negotiation module 272 could be performed by a hardware device or one implemented primarily or partially through hardware.

Marketing module 274 may perform functions relating to marketing new financial products and services to users of one or more audio chat devices 210. For instance, in some examples, marketing module 274 may generate new proposals for an existing account holder, based on information known about the user, including knowledge derived from offered information 279, as further described below. Marketing module 274 may design or customize marketing efforts based on a user's financial situation, interests, and/or financial needs. Marketing module 274 may design or customize proposals made to a user pursuant to such marketing efforts based on similar information. Marketing module 274 may cause bank computing system 260 to communicate information about new proposals to one or more audio chat devices 210. Marketing module 274 may receive information from and output information to one or more other modules, and may otherwise interact with and/or operate in conjunction with one or more other modules of bank computing system 260.

User account data store 278 may represent any suitable data structure or storage medium for storing information related to storing information about bank account holders or consumers of financial products and services (e.g., bank account information, transaction history, account types, account balances, credit scores, information about previous interactions, survey responses, information offered by a user or bank account holder). User account data store 278 may include or store offered information 279, received from one or more users of audio chat devices 210. Offered information 279 may, in some examples, be information offered by a user in response to a proposal generated by bank computing system 260 and presented by audio chat device 210. Such information may include a bank account number, an investment account number, a broker's name, a list of assets, and/or other information. The information stored in user account data store 278 may be searchable and/or categorized such that one or more modules within bank computing system 260 may provide an input requesting information from user account data store 278, and in response to the input, receive information stored within user account data store 278. User account data store 278 may be primarily maintained by negotiation module 272. User account data store 278 may store information that can be used to effectively market financial products and services to one or more users of audio chat devices 210. User account data store 278 may provide other modules with access to the data stored within user account data store 278, and/or may analyze the data stored within user account data store 278 and output such information on behalf of other modules of bank computing system 260.

Audio chat device 210 may, in some examples, be implemented as an interactive voice assistant, and may be a small, stationary device placed in a home setting. In some examples, audio chat device 210 may primarily detect input from users through occasional or continual analysis of users' spoken words, and may primarily output information and prompts to users through simulated speech. However, audio chat device 210 may be implemented as any suitable computing system, such as a mobile, non-mobile, wearable, and/or non-wearable computing device. Audio chat device 210 may be implemented through or represent a smart phone, a tablet computer, a computerized watch, a computerized glove or gloves, a personal digital assistant, a virtual assistant, a gaming system, a media player, an e-book reader, a television or television platform, a bicycle, automobile, or navigation, information and/or entertainment system for a bicycle, automobile or other vehicle, a laptop or notebook computer, a desktop computer, or any other type of wearable, non-wearable, mobile, or non-mobile computing device that may perform operations in accordance with one or more aspects of the present disclosure.

In the example of FIG. 2, audio chat device 210 may include power source 211, one or more processors 213, one or more communication units 215, one or more input devices 216, one or more output devices 217, one or more user interface devices 221, and one or more storage devices 230. User interface device 221 includes audio input device 222 and audio output device 224. Storage device 230 includes user interface module 231, audio processing module 232, and applications modules 239. One or more of the devices, modules, storage areas, or other components of audio chat device 210 may be interconnected to enable inter-component communications (physically, communicatively, and/or operatively). In some examples, such connectivity may be provided by through communication channels (e.g., communication channels 212), a system bus, a network connection, an inter-process communication data structure, or any other method for communicating data.

Power source 211 may provide power to one or more components of computing system 210. Power source 211 may receive power from the primary alternating current (AC) power supply in a building, home, or other location. In other examples, power source 211 may be a battery or a device that supplies direct current (DC). Power source 211 may be implemented in a manner similar to or consistent with other sources of power described herein.

One or more processors 213 of computing system 210 may implement functionality and/or execute instructions associated with computing system 210 or associated with one or more modules illustrated herein and/or described below. Processors 213 may be implemented in a manner similar to or consistent with the description of other processors or processing circuitry described herein.

One or more communication units 215 of computing system 210 may communicate with devices external to computing system 210 by transmitting and/or receiving data over a network or otherwise. Communication units 215 may be implemented in a manner similar to or consistent with the description of other communication units described herein.

User interface device 221 may function as an input and/or output device or set of input/output devices for audio chat device 210, and may be implemented using various devices, components, and/or technologies. User interface device 221 may include various types of input technologies, including presence-sensitive input panel technologies, microphone technologies, voice activation and/or recognition technologies, cameras, sensor technologies (e.g., infrared, image, location, motion, accelerometer, gyrometer, magnetometer), or other input device technology for use in receiving user input. User interface device 221 may include various types of output device technologies, including display devices, speaker technologies, haptic feedback technologies, tactile feedback technologies, light emitting technologies, or other output device technologies for use in outputting information to a user.

In the example of FIG. 2, user interface device 221 includes one or more audio input devices 222 and one or more audio output devices 224. Although certain components associated with audio chat device 210 are described or illustrated in FIG. 2 as being implemented within user interface device 221, in other examples, such components could be implemented external to user interface device 221, and other components could be implemented within user interface device 221. Further, while illustrated as an internal component of audio chat device 210, user interface device 221 may also represent an external or partially external component that shares a data path with audio chat device 210 for transmitting and/or receiving input and output. For instance, in some examples, user interface device 221 represents a built-in component of audio chat device 210 located within and physically connected to the external packaging of audio chat device 210 (e.g., a screen on a mobile phone). In other examples, user interface device 221 represents an external component of audio chat device 210 located outside and physically separated from the packaging or housing of audio chat device 210 (e.g., a monitor, a projector, etc. that shares a wired and/or wireless data path with audio chat device 210). In still other examples, one or more components of user interface device 221 may be built-in components of audio chat device 210, and one or more components of user interface device 221 may be external components of audio chat device 210 (e.g., some components of user interface device 221 may be internal, and others may be external). Further, one or more components of user interface device 221 may be integrated together, so that one component is or appears to be a built-in component of another (e.g., a display device and a presence-sensitive panel may be used together to implement a touch-screen display).

One or more input devices 216 may represent any input devices of audio chat device 210 not otherwise separately described herein. One or more input devices 216 may generate, receive, and/or process input from any type of device capable of detecting input from a human or machine. For example, one or more input devices 216 may generate, receive, and/or process input in the form of electrical, physical, audio, image, and/or visual input (e.g., peripheral device, keyboard, microphone, camera). In some examples, one or more input devices 216 may generate or receive input from a keyboard, pointing device, voice responsive system, video camera, button, sensor, mobile input device, control pad, microphone, presence-sensitive screen, network, or any other type of device for detecting input from a human or machine. In some examples, input devices 216 may include one or more sensor components one or more location sensors (GPS components, Wi-Fi® components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, step counter sensor.

One or more output devices 217 may represent any output devices of audio chat device 210 not otherwise separately described herein. One or more output devices 217 may generate, receive, and/or process input from any type of device capable of detecting input from a human or machine. For example, one or more output devices 217 may generate, receive, and/or process output in the form of electrical and/or physical output (e.g., peripheral device, actuator). In some examples, one or more output devices 217 may generate, present, and/or process output in the form of tactile, audio, visual, video, and other output. Output devices 217 may include a sound card, video graphics adapter card, speaker, presence-sensitive screen, one or more USB interfaces, video and/or audio output interfaces, a display, or any other type of device capable of generating tactile, audio, visual, video, or other output (e.g., a haptic response, a sound, a flash of light, and/or images). Some devices may serve as both input and output devices. For example, a communication device may both send and receive data to and from other systems or devices over a network. Also, a touch-sensitive or presence-sensitive display may both detect input in the form of physical taps or gestures, and present output in the form of visual information.

One or more storage devices 230 within audio chat device 210 may store information for processing during operation of audio chat device 210. Storage devices 230 may store program instructions and/or data associated with one or more of the modules described in accordance with one or more aspects of this disclosure. One or more processors 213 and one or more storage devices 230 may provide an operating environment or platform for such modules, which may be implemented as software, but may in some examples include any combination of hardware, firmware, and software. One or more processors 213 may execute instructions and one or more storage devices 230 may store instructions and/or data of one or more modules. The combination of processors 213 and storage devices 230 may retrieve, store, and/or execute the instructions and/or data of one or more applications, modules, or software. Processors 213 and/or storage devices 230 may also be operably coupled to one or more other software and/or hardware components, including, but not limited to, one or more of the components of audio chat device 210 and/or one or more devices or systems illustrated as being connected to audio chat device 210. Storage devices 230 may be implemented in a manner similar to or consistent with the description of other storage devices described herein.

User interface module 231 may manage user interactions with user interface device 221 and other components of audio chat device 210. User interface module 231 may cause user interface device 221 to output various user interfaces for display or presentation or otherwise, as a user of audio chat device 210 views, hears, or otherwise senses output and/or provides input at user interface device 221. User interface device 221 may detect input, and may output to user interface module 231 one or more indications of input as a user of audio chat device 210 interacts with a user interface presented at user interface device 221. User interface module 231 and user interface device 221 may interpret inputs detected at user interface device 221 and may relay information about the inputs detected at user interface device 221 to one or more associated platforms, operating systems, applications, and/or services executing at audio chat device 210 to cause audio chat device 210 to perform one or more functions.

User interface module 231 may receive information and instructions from a platform, operating system, application, and/or service executing at audio chat device 210 and/or one or more remote computing systems. In addition, user interface module 231 may act as an intermediary between a platform, operating system, application, and/or service executing at audio chat device 210 and various output devices of audio chat device 210 (e.g., speakers, LED indicators, audio or electrostatic haptic output devices, light emitting technologies, displays, etc.) to produce output (e.g., a graphic, a flash of light, a sound, a haptic response, etc.).

Audio processing module 232 may perform functions relating to performing voice recognition for audio sounds detected by user interface device 221 and translating signals received over network 109 into sounds that mimic a human voice. In some examples, audio processing module 232 may be capable of identifying a sound that corresponds to a human's voice. In other examples, audio processing module 232 may identify a particular user's voice or learn to identify a particular user's voice. Audio processing module 232 may also be capable of distinguishing a human voice from a recording of a human voice, and thereby perform at least some degree of voice authentication for sounds detected by user interface device 221. Audio processing module 232 may perform processing or translation of signals received over network 109 so that the signals can be used to generate audible sounds. Audio processing module 232 may interact with user interface module 231 to cause audio output device 224 to generate, from such translated signals, audible sounds that appear to be a human voice engaging in a discussion.

One or more applications modules 239 may represent some or all of the other various individual applications and/or services executing at and accessible from audio chat device 210. A user of audio chat device 210 may interact with a user interface (e.g., an interactive voice response or other user interface) associated with one or more applications modules 239 to cause audio chat device 210 to perform a function. Numerous examples of applications modules 239 may exist and may include banking applications, financial record-keeping applications, financial services applications, question and answer applications, search, communication, and shopping applications, and all other applications that may execute at audio chat device 210.

Modules illustrated in FIG. 2 (e.g., user interface module 231, audio processing module 232, applications modules 239, negotiation module 272, and marketing module 274) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

FIG. 2 illustrates one example implementation of system 200. Other example or alternative implementations of system 200 may be appropriate in other instances. Such implementations may include a subset of the devices and/or components included in the example of FIG. 2 and/or may include additional devices and/or components not shown in FIG. 2. Accordingly, although one or more implementations of system 200 of FIG. 2 are described, system 200 may be implemented in a number of other ways.

For instance, one or more devices of system 200 that are illustrated as separate devices may be implemented as a single device; one or more components of system 200 that are illustrated as separate components may be implemented as a single component. Also, in some examples, one or more devices of system 200 that are illustrated as a single device may be implemented as multiple devices; one or more components of system 200 that are illustrated as a single component may be implemented as multiple components. Each of the multiple devices and/or components may be directly coupled via wired or wireless communication and/or remotely coupled via one or more networks. Also, one or more devices or components illustrated in FIG. 2 may also be implemented as part of another device or component not shown in FIG. 2. In this and other ways, some of the functions described herein may be performed via distributed processing by two or more devices.

Further, certain operations, techniques, features, and/or functions are described herein as being performed by specific components, devices, and/or modules in FIG. 2. In other examples, such operations, techniques, features, and/or functions may be performed by different components, devices, or modules. Accordingly, some operations, techniques, features, and/or functions described herein as being attributed to one or more components, devices, or modules in FIG. 2 may, in other examples, be attributed to other components, devices, and/or modules, even if not specifically described herein in such a manner.

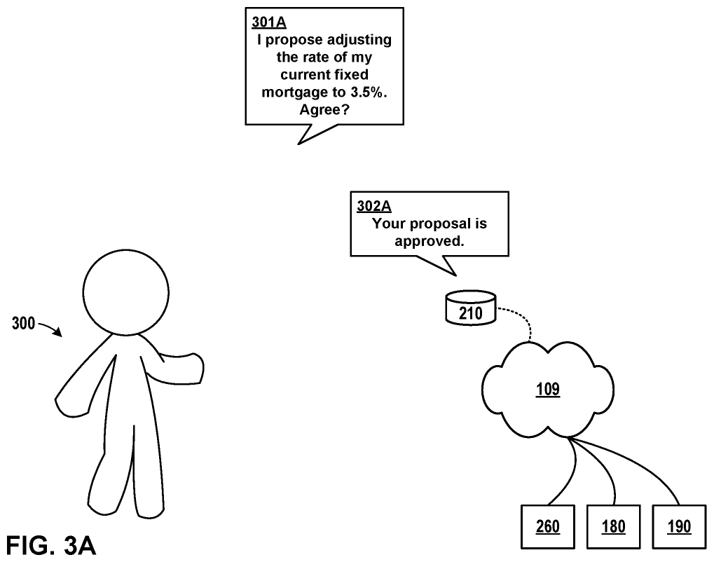

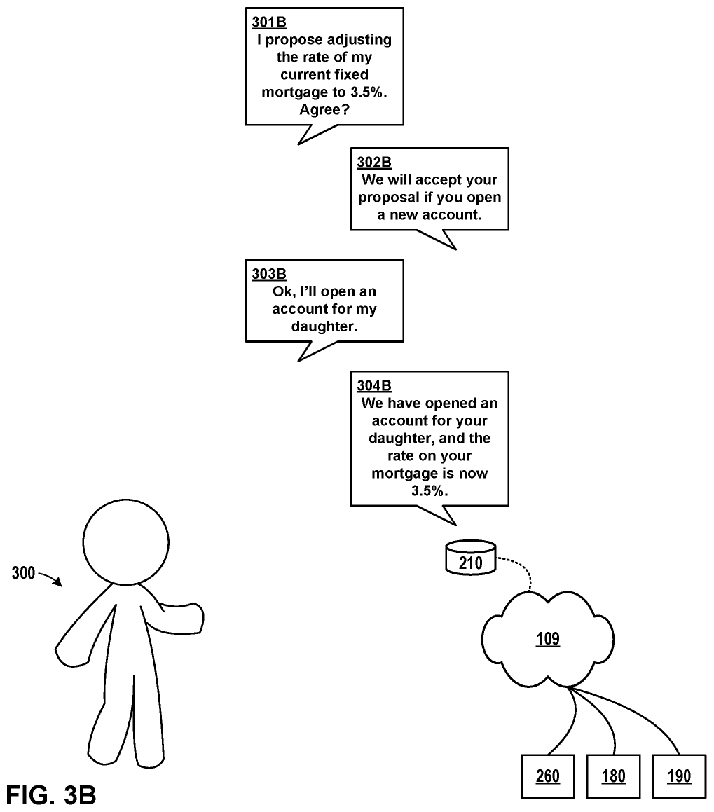

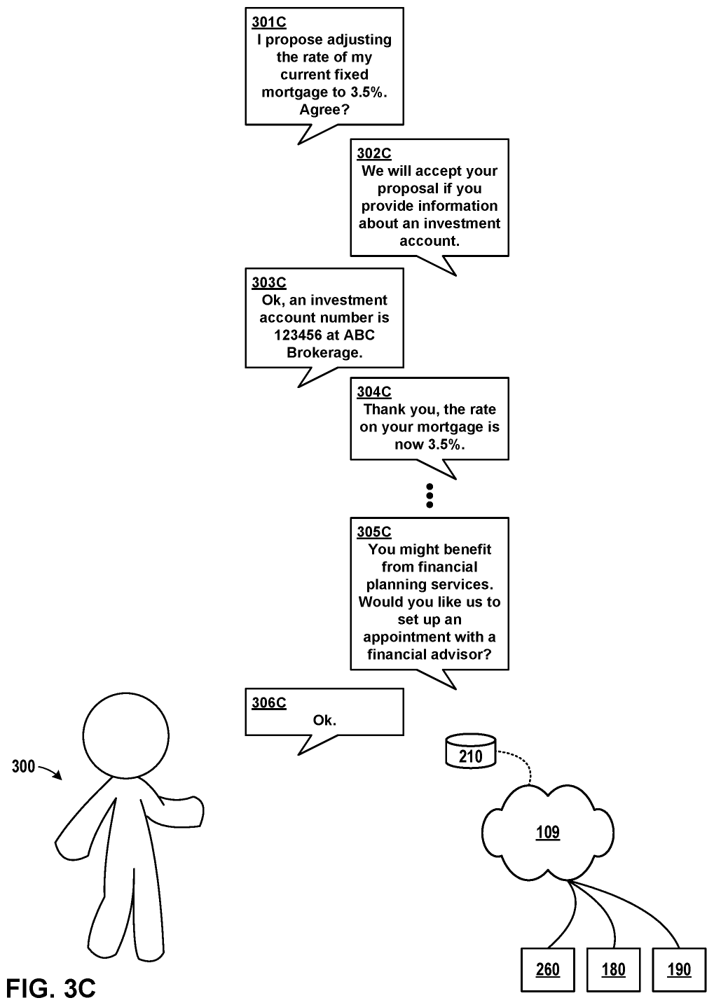

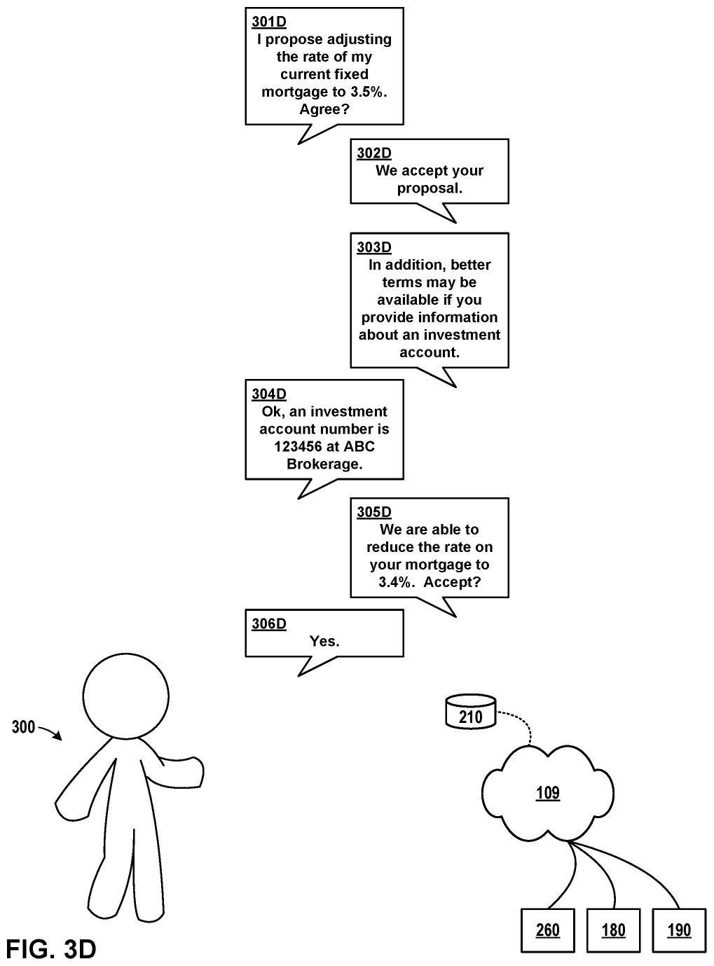

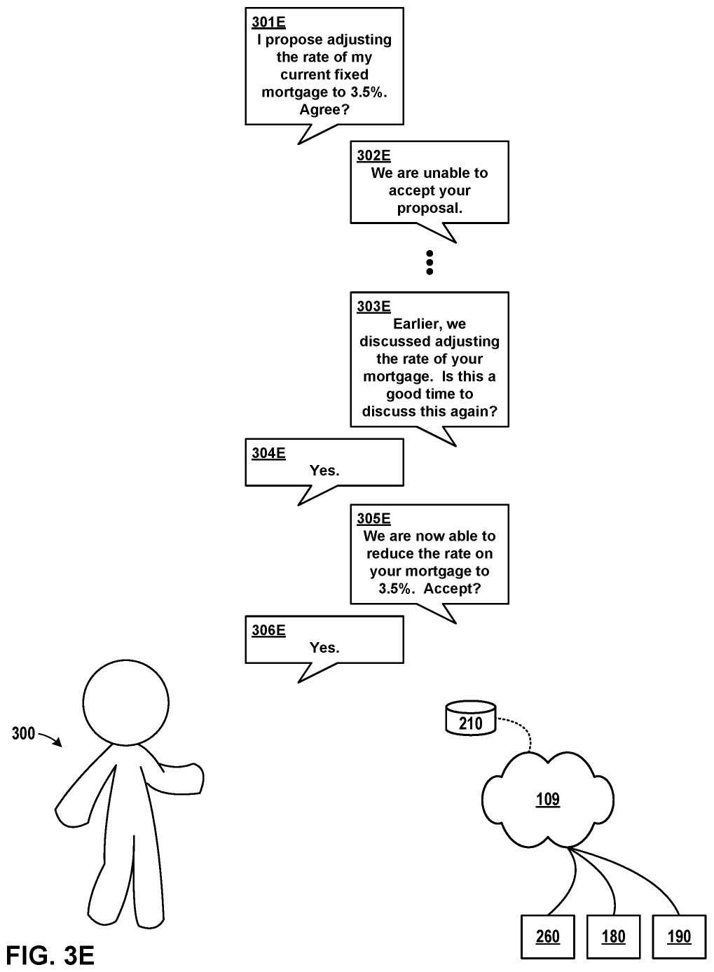

FIG. 3A, FIG. 3B, FIG. 3C, FIG. 3D, and FIG. 3E are conceptual diagrams illustrating the operation of an example bank computing system responding to a user's proposal detected by an example audio chat device, in accordance with one or more aspects of the present disclosure. In FIG. 3A through FIG. 3E, user 300 may interact with audio chat device 210 through voice commands. Audio chat device 210 and bank computing system 260 may communicate over network 109. Bank computing system 260 corresponds to bank computing system 260 illustrated in FIG. 2. Audio chat device 110 and/or bank computing system 260 may also communicate with information service computing system 180 and/or brokerage computing system 190 (see FIG. 1 and FIG. 2). One or more aspects of FIG. 3A through FIG. 3E may be described herein within the context of system 200 of FIG. 2.

In the example of FIG. 3, and in accordance with one or more aspects of the present disclosure, bank computing system 260 may receive a proposal from a user of audio chat device 210. For instance, in the example of FIG. 3A and with reference to FIG. 2, audio input device 222 of audio chat device 210 detects audio input and outputs to user interface module 231 an indication of input. User interface module 231 outputs information about the input to audio processing module 232. Audio processing module 232 determines that the input corresponds to voice input from a user of audio chat device 210 (e.g., user 300). Audio processing module 232 causes communication units 215 to output a signal over network 109. Communication units 265 of bank computing system 260 detect a signal over network 109 and output to negotiation module 272 an indication of the signal. Negotiation module 272 determines that the signal corresponds to a proposal from a user as illustrated in box 301A.

Negotiation module 272 may access information about the user of audio chat device 210 to determine whether to accept the user's proposal of box 301A. For instance, in the example of FIG. 3A and with reference to FIG. 2, negotiation module 272 accesses information within user account data store 278. The information within user account data store 278 may include information about accounts held by user 300 at bank 161 and other information about user 300. Negotiation module 272 may also access other information, including information about market rates, market conditions, and other information. Negotiation module 272 may further access information from information services. For instance, in some examples, negotiation module 272 may cause communication units 265 to output a signal over network 109. Information service computing system 180 may detect a signal over network 109 and determine that the signal includes a request for information. Information service computing system 180 may further determine that the request is for information specifically about user 300. Information service computing system 180 outputs a signal over network 109. Communication units 265 of bank computing system 260 detect a signal over network 109 and output to negotiation module 272 an indication of a signal. Negotiation module 272 determines that the signal includes information responsive to the request sent by negotiation module 272.

Bank computing system 260 may accept the user's proposal and inform the user that the proposal was accepted. For instance, in the example of FIG. 3A and with reference to FIG. 2, negotiation module 272 determines, based on the information accessed within user account data store 278, the information received from information service computing system 180, and/or other information, that the proposal is acceptable to bank 161. Negotiation module 272 causes communication units 265 to output a signal over network 109. Communication units 215 of audio chat device 210 detect a signal over network 109 and output to user interface module 231 an indication of the signal. User interface module 231 outputs to audio processing module 232 information about the signal. Audio processing module 232 determines that the signal includes information sufficient to produce audio information. Audio processing module 232 causes user interface module 231 to generate audible sounds through audio output device 224 corresponding to box 302A, thereby informing user 300 that his or her proposal was accepted. Negotiation module 272 updates information in user account data store 278 to include information about the accepted proposal and to include information about the new terms of the user's mortgage.

In other examples, rather than accepting the proposal, bank computing system 260 may deny the proposal. For instance, in such an example, bank computing system 260 determines, based on the accessed information and/or other information, that the user's proposal will not be accepted by bank 161. In such an example, negotiation module 272 may communicate with audio chat device 210 over network 109 and cause audible sounds to be presented by audio chat device 210 that inform user 300 that his or her proposal was not accepted. Negotiation module 272 may also update information in user account data store 278 to reflect that a proposal was received from the user and subsequently denied.

In FIG. 3B, bank computing system 260 may respond to a proposal with a counterproposal. For instance, in the example of FIG. 3B and with reference to FIG. 2, audio input device 222 of audio chat device 210 detects audio input and outputs to user interface module 231 an indication of input. User interface module 231 outputs information about the input to audio processing module 232. Audio processing module 232 determines that the input corresponds to voice input from a user of audio chat device 210. Audio processing module 232 causes communication units 215 to output a signal over network 109. Communication units 265 of bank computing system 260 detect a signal over network 109 and output to negotiation module 272 an indication of the signal. Negotiation module 272 determines that the signal corresponds to a proposal from user 300 corresponding to the description of the proposal in box 301B. Negotiation module 272 accesses information about user 300 in user account data store 278 and/or elsewhere. Negotiation module 272 generates a counterproposal. Negotiation module 272 causes communication units 265 to output a signal over network 109. Communication units 215 of audio chat device 210 detect a signal over network 109 and output to user interface module 231 an indication of the signal. User interface module 231 outputs to audio processing module 232 information about the signal. Audio processing module 232 determines that the signal includes information sufficient to produce audible sounds simulating a voice. Audio processing module 232 causes user interface module 231 to generate audible sounds through audio output device 224 corresponding to box 302B, thereby presenting the counterproposal to user 300.

Bank computing system 260 may determine that the user has accepted the counterproposal. For instance, in the example of FIG. 3B and with reference to FIG. 2, audio input device 222 detects audio input (i.e., box 303B) that audio processing module 232 determines corresponds to voice input. Audio processing module 232 causes communication units 215 to output a signal over network 109. Communication units 265 receive a signal over network 109 that negotiation module 272 determines corresponds to acceptance of the counterproposal. Negotiation module 272 causes a new account to be opened for the user's daughter. Negotiation module 272 adjusts records in user account data store 278 to reflect the new account. Negotiation module 272 may also update information in user account data store 278 to include information about the accepted counterproposal and to include updated information about the terms of the user's mortgage.

Bank computing system 260 may respond to the acceptance of the counterproposal by confirming that the counterproposal has taken effect. For instance, in the example of FIG. 3B and with reference to FIG. 2, negotiation module 272 causes communication units 265 to output a signal over network 109. Communication units 215 receive a signal over network 109 that audio processing module 232 determines includes audio information. Audio processing module 232 causes audio output device 224 to generate audible sounds corresponding to box 304B.

In FIG. 3C, bank computing system 260 may respond to a proposal with a counterproposal requesting information about the user. For instance, in the example of FIG. 3C and with reference to FIG. 2, audio chat device 210 detects audio input and communicates information about the audio input to bank computing system 260 over network 109, as described in connection with FIG. 3A and FIG. 3B. Negotiation module 272 of bank computing system 260 determines that the audio input corresponds to the proposal shown in box 301C. Negotiation module 272 generates a counterproposal, and communicates the counterproposal over network 109 to audio chat device 210. Audio chat device 210 generates audible sounds corresponding to the counterproposal shown in box 302C.

Bank computing system 260 may determine that the user has accepted the counterproposal and offered the requested information. For instance, in the example of FIG. 3C and with reference to FIG. 2, audio chat device 210 detects audio input and communicates information about the audio input to bank computing system 260 over network 109. Negotiation module 272 of bank computing system 260 determines that the audio input corresponds to acceptance of the counterproposal. Negotiation module 272 further determines that the audio input includes information corresponding to the information requested in the counterproposal. Specifically, box 303C includes the information requested by bank computing system 260 and offered by the user (“offered information 279”). Negotiation module 272 stores offered information 279 in user account data store 278. Negotiation module 272 may also update information in user account data store 278 to include information about the accepted counterproposal and to include updated information about the terms of the user's mortgage.

Bank computing system 260 may, based on the offered information or other information, market additional financial products and/or services. For instance, in the example of FIG. 3C, and some time after the user's mortgage was adjusted as described in box 301C and confirmed in box 304C, marketing module 274 of bank computing system 260 accesses information in user account data store 278. In some examples, the information accessed includes offered information 279 received earlier from audio chat device 210 by bank computing system 260. Marketing module 274 determines, based on the accessed information and/or other information, a new proposal for the user relating to a financial product or service that may of interest to the user, or may be appropriate or applicable to the user. Bank computing system 260 communicates information about the new proposal over network 109 to audio chat device 210. Audio chat device 210 generates audible sounds corresponding to the new proposal shown in box 305C.

Bank computing system 260 may determine that the user has accepted the new proposal. For instance, in the example of FIG. 3C and with reference to FIG. 2, audio chat device 210 detects audio input and communicates information about the audio input to bank computing system 260 over network 109. Negotiation module 272 of bank computing system 260 determines that the audio input corresponds to acceptance of the new proposal (box 306C). Negotiation module 272 acts on the acceptance by, for example, scheduling an appointment, and updating information about the appointment and the new financial service being provided to the user in user account data store 278.

In FIG. 3D, bank computing system 260 may approve a user's proposal and also offer a counterproposal. For instance, in the example of FIG. 3D, audio chat device 210 detects audio input and communicates information about the audio input to bank computing system 260 over network 109. Negotiation module 272 of bank computing system 260 determines that the audio input corresponds to the proposal shown in box 301D. Negotiation module 272 determines that the proposal is acceptable to bank 161. In addition, negotiation module 272 generates a conditional counterproposal for consideration by user 300. Bank computing system 260 communicates information about the acceptance and the conditional counterproposal over network 109 to audio chat device 210. Audio chat device 210 generates audible sounds corresponding to the acceptance (box 302D) and the conditional counterproposal (box 303D).

In some examples, user 300 might simply accept the terms of his or her original proposal (box 301D). In the example of FIG. 3D, however, user 300 accepts the counterproposal. For instance, in the example of FIG. 3D and with reference to FIG. 2, audio chat device 210 detects audio input and communicates information about the audio input to bank computing system 260 over network 109. Negotiation module 272 determines that the audio input corresponds to acceptance of the conditional counterproposal. Negotiation module 272 further determines that the audio input includes information corresponding to the information requested in box 303D. Negotiation module 272 stores the requested information in user account data store 278 as offered information 279.

Bank computing system 260 may generate a proposal based on the user's response. For instance, in the example of FIG. 3D and with reference to FIG. 2, negotiation module 272 generates, based on offered information 279, proposed terms. Bank computing system 260 communicates information about the proposed terms over network 109 to audio chat device 210. Audio chat device 210 generates audible sounds corresponding to the proposed terms as illustrated in box 305D. Bank computing system 260 may thereafter receive an indication of an acceptance over network 109 from audio chat device 210. In such an example, bank computing system 260 updates information in user account data store 278 to include information about the accepted counterproposal and to include updated information about the terms of the user's mortgage.

In FIG. 3E, bank computing system 260 may deny a user's proposal, but may reconsider the user's proposal if circumstances change. For instance, in the example of FIG. 3E and with reference to FIG. 2, audio chat device 210 detects audio input and communicates information about the audio input to bank computing system 260 over network 109. Negotiation module 272 of bank computing system 260 determines that the audio input corresponds to the proposal shown in box 301E. Negotiation module 272 determines that bank 161 is not willing to accept the proposal. Bank computing system 260 communicates information about the refusal to accept the proposed terms over network 109 to audio chat device 210. Audio chat device 210 generates audible sounds corresponding to the refusal to accept the proposed terms (box 302E). Although the user's proposal was denied, negotiation module 272 stores information about the user's proposal in user account data store 278. Negotiation module 272 continues to monitor circumstances and occasionally reconsiders the user's proposal.

Bank computing system 260 may, after initially refusing to accept the user's proposed terms in box 301E, later accept the proposed terms. For instance, in the example of FIG. 3E and with reference to FIG. 2, and weeks, months, or years after the initial denial (box 302E), negotiation module 272 may determine that, based on changed market conditions, a changed financial condition of user 300, or other circumstances, that bank 161 will now accept the terms originally proposed by user 300 (box 301E). Accordingly, bank computing system 260 communicates information about the earlier proposal over network 109 to audio chat device 210. Audio chat device 210 generates audible sounds corresponding to the prompt of box 303E. Audio chat device 210 detects audio input (box 304E) and communicates information about the audio input to bank computing system 260 over network 109. In response, bank computing system 260 communicates information over network 109 to audio chat device 210, and audio chat device 210 generates audible sounds corresponding to box 305E. Bank computing system 260 detects a signal over audio chat device 210 indicating that user 300 is still interested in adjusting the terms of his or her mortgage. Bank computing system 260 updates information in user account data store 278 to reflect the new terms of the user's mortgage and communicates a confirmation to audio chat device 210 over network 109.

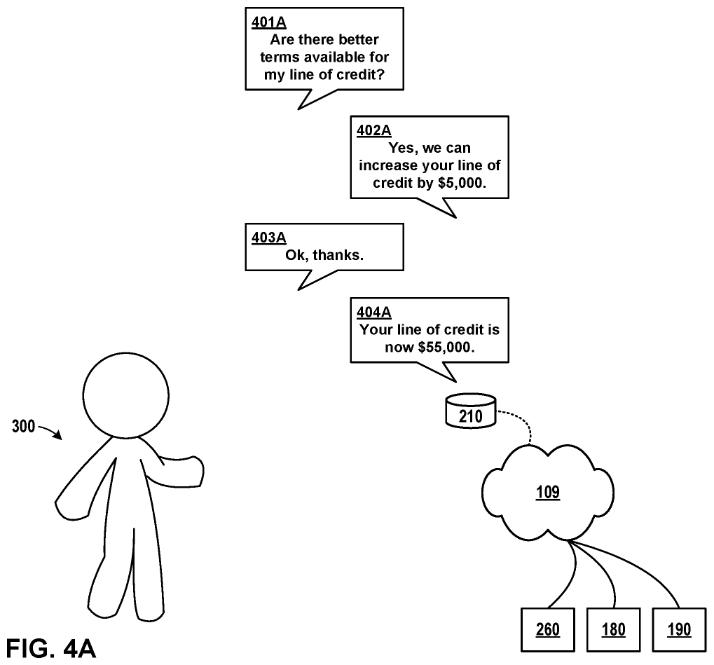

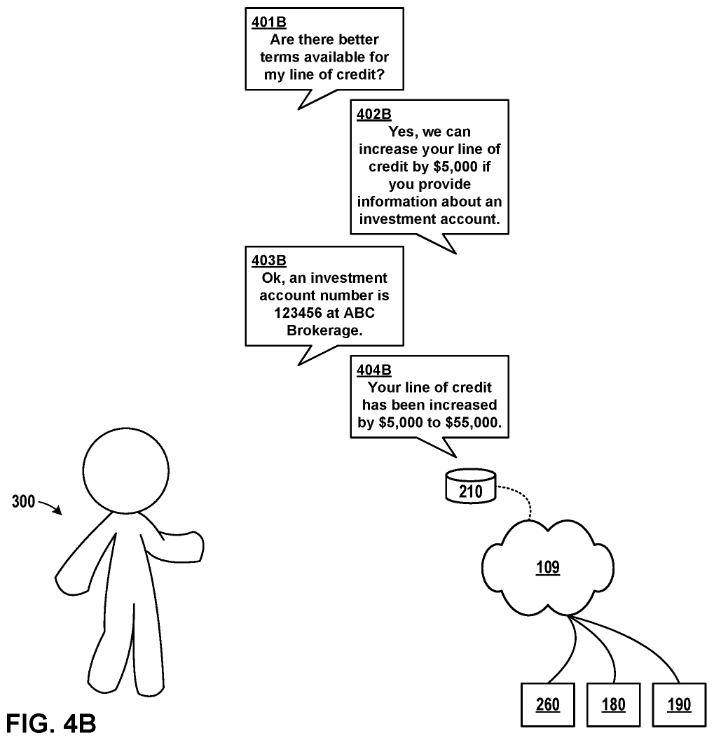

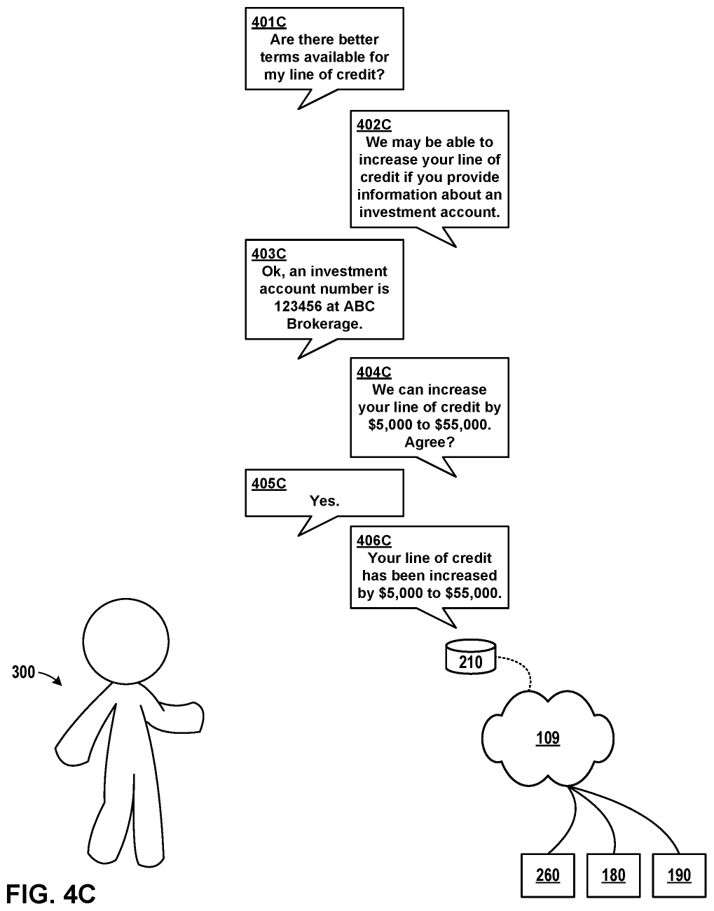

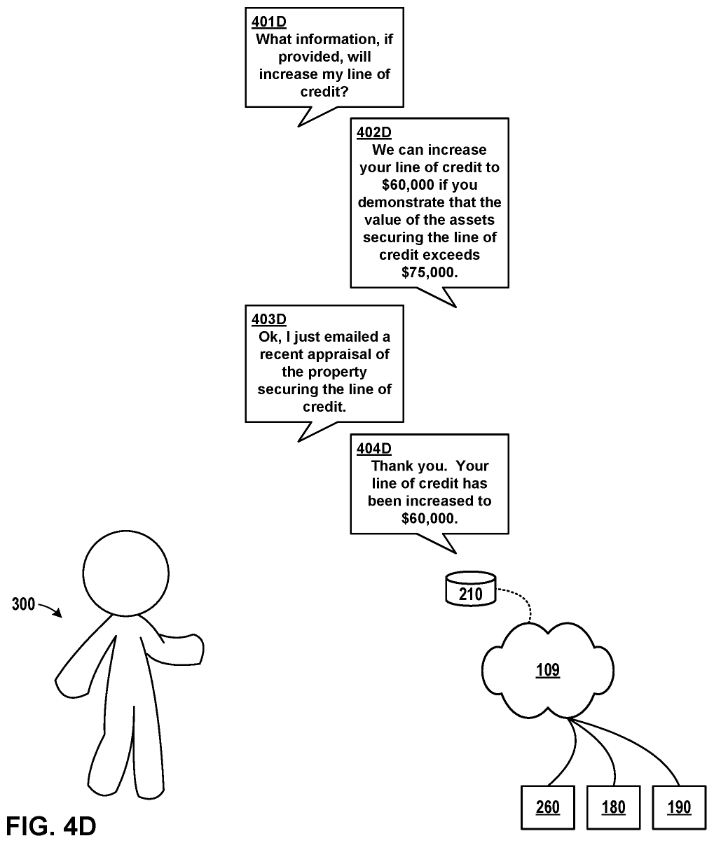

FIG. 4A, FIG. 4B, FIG. 4C, and FIG. 4D are conceptual diagrams illustrating the operation of an example bank computing system responding to a user's question detected by an example audio chat device, in accordance with one or more aspects of the present disclosure. In FIG. 4A through FIG. 4D, user 300 may interact with audio chat device 210 through voice commands. Audio chat device 210 and bank computing system 260 may communicate over network 109. Audio chat device 110 and/or bank computing system 260 may also communicate with information service computing system 180 and/or brokerage computing system 190. One or more aspects of FIG. 4A through FIG. 4D may be described herein within the context of system 200 of FIG. 2.

In FIG. 4A, bank computing system 260 may respond to a user's query with a proposal. For instance, in the example of FIG. 4A and with reference to FIG. 2, audio chat device 210 detects audio input (box 401A) and communicates information about the audio input to bank computing system 260 over network 109. Negotiation module 272 of bank computing system 260 determines that the audio input corresponds to an open-ended request to negotiate the terms of a particular financial product or service used by user 300. In this case, the financial product that is the subject of the user's request is a credit card. Negotiation module 272 of bank computing system 260 accesses information in user account data store 278. Marketing module 274 determines, based on the accessed information and/or other information, a proposed modification of the terms for the user's credit card. Bank computing system 260 communicates information about the proposed modification of the credit card terms over network 109 to audio chat device 210. Audio chat device 210 generates audible sounds describing the proposed modification.

Bank computing system 260 may determine that user 300 has accepted the proposal. For instance, in the example of FIG. 4B and with reference to FIG. 2, audio chat device 210 detects audio input and communicates information about the audio input to bank computing system 260 over network 109. Negotiation module 272 of bank computing system 260 determines that the audio input corresponds to acceptance of the modified terms.

Bank computing system 260 may confirm the modified terms and store information about the modification. For instance, in the example of FIG. 4B and with reference to FIG. 2, negotiation module 272 generates a response to the acceptance, which bank computing system 260 communicates over network 109 to audio chat device 210. Audio chat device 210 generates audible sounds confirming the modified terms (box 404A). Negotiation module 272 updates user account data store 278 to include information about the negotiation illustrated in FIG. 4A, and information about the new terms for the user's credit card.

In FIG. 4A, bank computing system 260 may respond to a user's query with a proposal and a request for information. For instance, in the example of FIG. 4B, and as in FIG. 4A, audio chat device 210 communicates information about detected audio input (box 401B) to bank computing system 260 over network 109, and bank computing system 260 determines that the audio input corresponds to an open-ended request to negotiate the terms of the user's credit card. Negotiation module 272 generates, based on information stored in user account data store 278 or other information, a conditional counterproposal. Bank computing system 260 communicates information about the conditional counterproposal over network 109 to audio chat device 210, and audio chat device 210 generates audible sounds describing the conditional counterproposal (box 402B). Audio chat device 210 communicates information about detected audio input (box 403B) to bank computing system 260 over network 109. Negotiation module 272 of bank computing system 260 determines that the audio input corresponds to acceptance of the conditional counterproposal and also the requested information. Bank computing system 260 communicates a confirmation to audio chat device 210 over network 109, and audio chat device 210 generates audio sounds consistent with the confirmation (box 404B).

In FIG. 4C, bank computing system 260 may respond to a user's query with a potential proposal and a request for information. For instance, in the example of FIG. 4C, and as in FIG. 4A and FIG. 4B, audio chat device 210 communicates information about detected audio input (box 401C) to bank computing system 260 over network 109, and bank computing system 260 determines that the audio input corresponds to an open-ended request to negotiate the terms of the user's credit card. Negotiation module 272 generates, based on information stored in user account data store 278 or other information, a response. Bank computing system 260 communicates information about the response over network 109 to audio chat device 210, and audio chat device 210 generates audible sounds describing the response (box 402C). In the example of FIG. 4C, the response includes a request for information, but no specific proposal.

Bank computing system 260 may present a proposal after analyzing information provided by the user. For instance, in the example of FIG. 4C and with reference to FIG. 2, audio chat device 210 communicates information about detected audio input (box 403C) to bank computing system 260 over network 109. Negotiation module 272 of bank computing system 260 determines that the audio input corresponds to information offered by the user in response to the request illustrated in box 402C. Negotiation module 272 stores the information in user account data store 278 as offered information 279, which is derived from the information received from audio chat device 210 over network 109. Negotiation module 272 generates, based on offered information 279, a proposal. Bank computing system 260 communicates information about the proposal over network 109 to audio chat device 210, and audio chat device 210 generates audio describing the proposal (box 404C). In some examples, negotiation module 272 may be unable to generate a proposal responsive to the user's request. In such an example, bank computing system 260 might not communicate information about a proposal over network 109 to audio chat device 210.

In FIG. 4D, bank computing system 260 may respond to a user's open-ended query with a proposal. For instance, in the example of FIG. 4C and with reference to FIG. 2, audio chat device 210 communicates information about detected audio input (box 401D) to bank computing system 260 over network 109. Negotiation module 272 determines that the audio input corresponds to an offer to provide information in exchange for increasing an existing line of credit. Negotiation module 272 generates, based on information stored in user account data store 278 or other information, a proposal. Bank computing system 260 communicates information about the proposal over network 109 to audio chat device 210, and audio chat device 210 generates audible sounds describing the proposal (box 402D). In response, audio chat device 210 communicates information about detected audio input (box 403D) to bank computing system 260 over network 109. Negotiation module 272 of bank computing system 260 determines that the audio input corresponds to acceptance of the proposal and makes reference to providing the requested information through another channel. Bank computing system 260 accesses and analyzes the offered information. Bank computing system 260 communicates a confirmation to audio chat device 210 over network 109, and audio chat device 210 generates audio sounds consistent with the confirmation (box 404D).

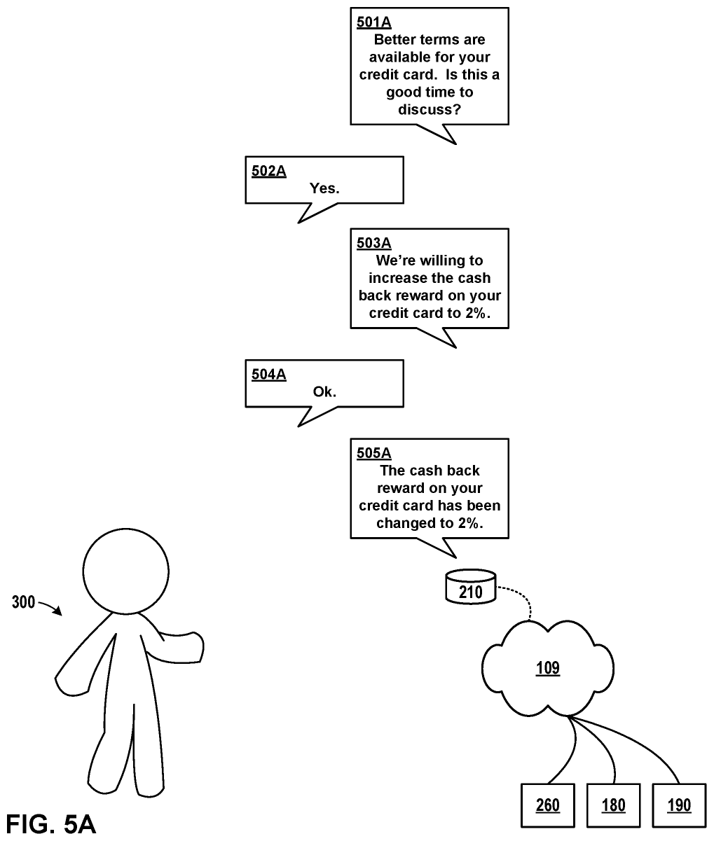

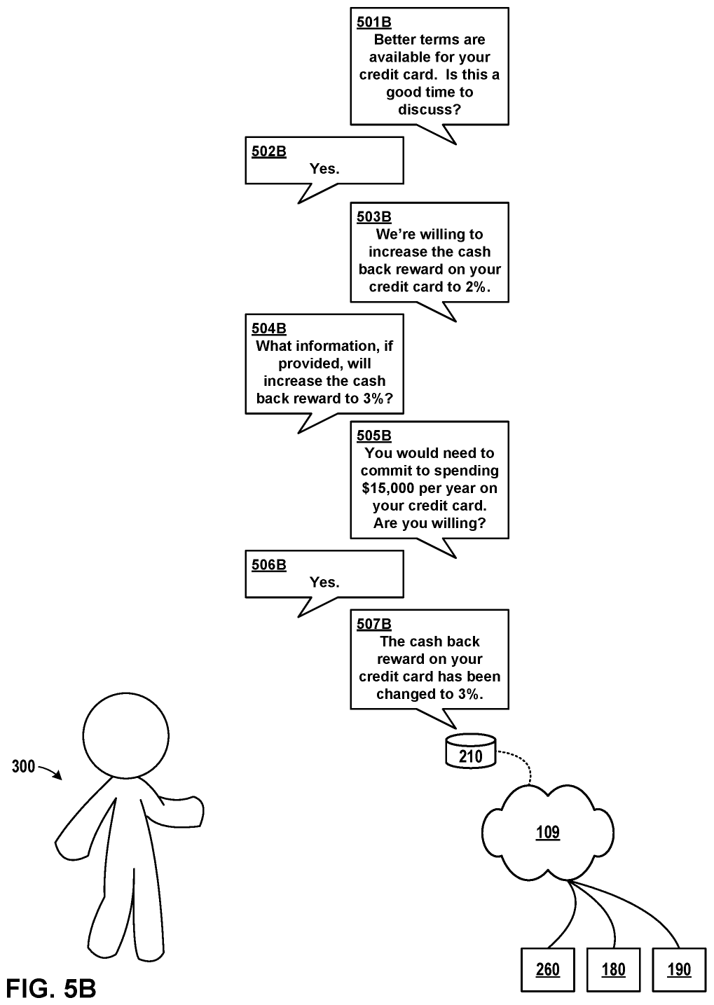

FIG. 5A and FIG. 5B are conceptual diagrams illustrating the operation of an example bank computing system initiating a negotiation with a user of an example audio chat device, in accordance with one or more aspects of the present disclosure. In FIG. 5A and FIG. 5B, user 300 may interact with audio chat device 210 through voice commands. Audio chat device 210 and bank computing system 260 may communicate over network 109. Audio chat device 110 and/or bank computing system 260 may also communicate with information service computing system 180 and/or brokerage computing system 190. One or more aspects of FIG. 5A and FIG. 5B may be described herein within the context of system 200 of FIG. 2.

In FIG. 5A, bank computing system 260 may generate a proposal and obtain approval from user 300 to initiate a negotiation about the proposal. For instance, in the example of FIG. 5A and with reference to FIG. 2, marketing module 274 of bank computing system 260 generates, based on information in user account data store 278 or elsewhere, a proposal. Bank computing system 260 communicates a request to discuss the proposal to audio chat device 210 over network 109, and audio chat device 210 generates audio corresponding to the request (box 501A). In response, audio chat device 210 communicates information about detected audio (box 502A) to bank computing system 260 over network 109. Marketing module 274 determines that the audio indicates an acceptance to discuss the proposal.

Bank computing system 260 may communicate the proposal to user 300 and determine that user 300 has accepted the proposal. For instance, in the example of FIG. 5A, marketing module 274 causes bank computing system 260 to communicate information about the proposal to audio chat device 210 over network 109, and audio chat device 210 generates audio describing the proposal (box 503A). Audio chat device 210 communicates information about detected input to bank computing system 260 over network 109, which negotiation module 272 determines corresponds to acceptance of the proposal. Marketing module 274 updates user account data store 278 to include information about the negotiation illustrated in FIG. 5A, and to reflect the new terms of the user's credit card.

In FIG. 5B, as in FIG. 5A, bank computing system 260 may generate a proposal and obtain approval from user 300 to initiate a negotiation about the proposal. For instance, in the example of FIG. 5B and with reference to FIG. 2, marketing module 274 of bank computing system 260 generates a proposal and communicates a request to discuss the proposal to audio chat device 210 over network 109. Audio chat device 210 generates audio output corresponding to the request (box 501B), and audio chat device 210 communicates to bank computing system 260 information about audio input (box 502B) detected in response to the audio output. Marketing module 274 determines that the information indicates an acceptance to discuss the proposal.

Bank computing system 260 may communicate the proposal to user 300 and determine that user 300 has responded with a query. For instance, in the example of FIG. 5B, and like FIG. 5A, marketing module 274 causes bank computing system 260 to communicate information about the proposal to audio chat device 210 over network 109, and audio chat device 210 generates audio describing the proposal (box 503B). Audio chat device 210 thereafter communicates information about detected audio (box 504B) to bank computing system 260 over network 109. In this example, marketing module 274 determines that the audio corresponds to a request, by the user, to further negotiate the terms of the user's credit card. Marketing module 274 generates a response to the request. Bank computing system 260 communicates information about the response over network 109 to audio chat device 210, and audio chat device 210 generates audible sounds (box 505B) describing the response and including a proposal for modifying the terms in the manner requested by user 300. Audio chat device 210 communicates information about detected audio (box 506B) to bank computing system 260 over network 109. Marketing module 274 determines that the audio input corresponds to the commitment requested in the response. Bank computing system 260 communicates a confirmation to audio chat device 210 over network 109, and audio chat device 210 generates audio sounds consistent with the confirmation (box 507B).

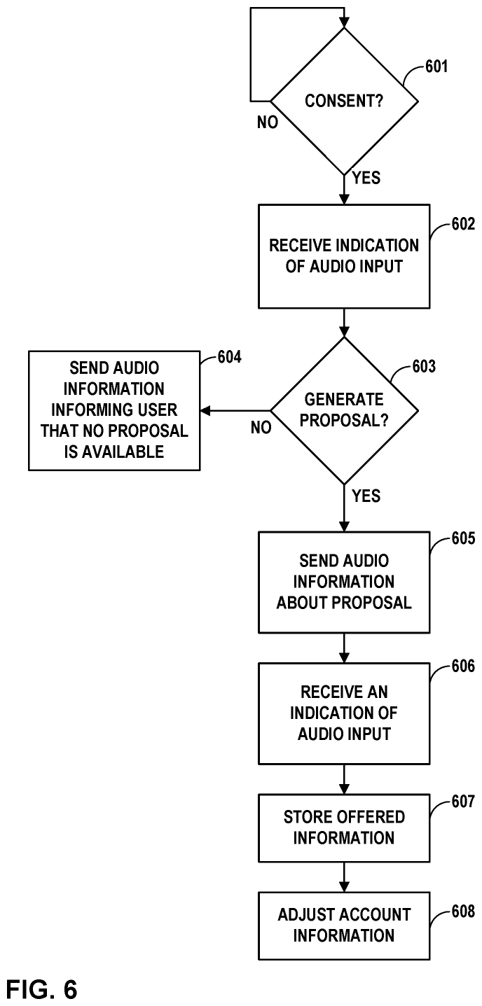

FIG. 6 is a flow diagram illustrating operations performed by an example bank computing system in accordance with one or more aspects of the present disclosure. FIG. 6 is described below within the context of bank computing system 260 of FIG. 2. In other examples, operations described in FIG. 6 may be performed by one or more other components, modules, systems, or devices. Further, in other examples, operations described in connection with FIG. 6 may be merged, performed in a difference sequence, or omitted.

In the example of FIG. 6, and in accordance with one or more aspects of the present disclosure, bank computing system 260 may receive consent from the user to process audio information detected by audio chat device 210 (601). For example, particularly in situations where an audio data stream may be sent to a remote system for processing by, for example, negotiation module 272 and/or marketing module 274 of bank computing system 260, as described herein, bank computing system 260 may cause audio chat device 210 to request permission to process the audio data stream remotely. In such an example, bank computing system 260 may output, over network 109, a description of the type of processing that may be done remotely based on audio information detected at audio chat device 210. Such a description may also specify how such information may be used (e.g., for marketing new financial products and services that are relevant to a user's interests, financial situation, or lifestyle). After providing such information (generating audio describing the information), audio chat device 210 may detect audio input and transmit an indication of audio input over network 109 to bank computing system 260. Bank computing system 260 may determine that the input corresponds to unambiguous and explicit consent to use such information. Bank computing system 260 might receive such consent periodically (e.g., once a month, annually), or in some examples, bank computing system 260 may receive such consent only once (e.g., upon initial setup of bank computing system 260). If no such consent is received, bank computing system 260 may refrain from performing one or more operations illustrated in FIG. 6 until bank computing system 260 obtains explicit consent.

Bank computing system 260 may receive a first indication of audio input associated with a user (602). For example, audio chat device 210 may detect audio input and output over network 109 an indication of input. Bank computing system 260 may detect a signal over network 109 and determine that the signal corresponds to an indication of audio input associated with the user of audio chat device 210. Bank computing system 260 may further determine that the audio input corresponds to the user proposing to raise his or her credit limit to $10,000, and asking “what information, if provided, will increase my credit limit to $10,000?”

Bank computing system 260 may generate a proposal relating to a financial product, wherein the proposal includes a request for information (603). For example, bank computing system 260 accesses information stored in user account data store 278, and determines what information would be sufficiently valuable to bank 161 to justify raising the user's credit limit as requested. Based on such a determination, bank computing system 260 generates a counterproposal that includes a request that the user provide information about additional assets.

In some examples, bank computing system 260 may be unable to generate an acceptable proposal (NO path from 603). In such an example, bank computing system 260 may output a signal over network 109. Audio chat device 210 may detect a signal over network 109 and determine that the signal includes audio information for presentation to a user. Audio chat device 210 may cause audio output device 224 to generate audible sounds informing a user of audio chat device 210 that bank 161 is unable to raise the user's credit limit (604).

Where a proposal is generated, bank computing system 260 may send, over network 109, audio information about the proposal (605). For example, bank computing system 260 outputs a signal over network 109. Audio chat device 210 detects a signal over network 109 and determines that the signal includes audio information for presentation to a user. Audio chat device 210 causes audio output device 224 to generate audible sounds describing the counterproposal, thereby informing a user of audio chat device 210 of the terms of the counterproposal, including the request for information about additional assets.

Bank computing system 260 may receive, over the network, a second indication of audio input including offered information responsive to the request for information (606). For example, audio chat device 210 may detect audio input and cause communication units 215 to output a signal over network 109. Communication units 265 detect a signal over network 109 and output an indication of a signal to negotiation module 272. Negotiation module 272 determines that the signal includes information that is responsive to the requested information about additional assets.

Bank computing system 260 may store the offered information (607). For example, negotiation module 272 of bank computing system 260 stores data derived from the information about additional assets as offered information 279 within user account data store 278.

Bank computing system 260 may adjust the account information associated with the user to reflect acceptance of the proposal (608). For example, bank computing system 260 modifies information within user account data store 278 to reflect acceptance of the terms of the counterproposal, and to reflect the new credit limit associated with one or more accounts held by the user.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth above is intended as a description of various configurations and is not intended to represent the only configurations in which the concepts described herein may be practiced. The detailed description includes specific details for the purpose of providing a thorough understanding of the various concepts. However, these concepts may be practiced without these specific details. In some instances, well-known structures and components are shown in block diagram form in the referenced figures in order to avoid obscuring such concepts.

As used in this disclosure, the phrases “financial products” and “financial services” may be used herein interchangeably, and a reference to one may be interpreted as a reference to the other. Also, in accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

1. A method comprising:
performing, by an audio monitoring device located within a user's home, continual analysis of the user's spoken words;
receiving, by a computing system and over a network from the audio monitoring device, a first indication of audio input associated with the user, wherein the first indication of audio input includes a user proposal;
collecting, by the computing system and from an information source on the network, risk information about the user;
determining, based on the collected risk information, additional information that, if received from the user, is sufficient to make the user proposal acceptable;
generating, by the computing system, a proposal relating to a financial product, wherein the proposal is a counterproposal based on account information associated with the user, the user proposal, and the collected risk information about the user, and wherein the proposal includes a request for the additional information;
sending, by the computing system over the network and for presentation by the audio monitoring device, information about the proposal;
responsive to sending the information about the proposal, receiving, by the computing system and over the network, a second indication of audio input associated with the user including offered information responsive to the request for the additional information;
storing, by the computing system, the offered information; and
adjusting, by the computing system, the account information associated with the user to reflect acceptance of the proposal.

2. (canceled)

3. The method of claim 1,
wherein the user proposal includes an offer to provide information; and
wherein generating the proposal includes identifying information that, if received from the user, is sufficient to make the user proposal acceptable.

4. The method of claim 1, wherein the financial product is a first financial product, the method further comprising:
generating, by the computing system and based on the offered information, a new proposal associated with a second financial product that is different than the first financial product;
sending, by the computing system and over the network, information about the new proposal;
responsive to sending the information about the new proposal, receiving, by the computing system and over the network, a third indication of audio input associated with the user;
determining, by the computing system and based on the third indication of audio input, that the user has accepted the new proposal; and
further adjusting, by the computing system, the account information associated with the user to reflect acceptance of the new proposal.

5. The method of claim 1, wherein the user proposal is a first user proposal, the method further comprising:
receiving, by the computing system and over the network, a second user proposal;
determining, by the computing system, that the second user proposal is not acceptable;
sending, by the computing system and over the network, information indicating that the second user proposal has been denied;
identifying, by the computing system and after sending the information indicating that the second user proposal has been denied, changed circumstances relating to the second user proposal;
determining, by the computing system and based on the changed circumstances, that the second user proposal is acceptable;
sending, by the computing system and over the network, information requesting further communications relating to the second user proposal;
receiving, by the computing system and over the network, an indication of further communications; and
further adjusting, by the computing system and based on the indication of further communications, the account information associated with the user to reflect acceptance of the second user proposal.

6. The method of claim 1, wherein receiving the first indication of audio input includes receiving a plurality of indications of audio input, the method further comprising:
sending, by the computing system and over the network, information responsive to each of the plurality of indications of audio input.

7. The method of claim 6, wherein generating the proposal relating to the financial product includes generating the proposal based on the plurality of indications of audio input.

8. A computing system comprising:
a storage device; and
processing circuitry having access to the storage device and configured to:
enable an audio monitoring device located within a user's home to perform continual analysis of the user's spoken words,
receive, over a network and from the audio monitoring device, a first indication of audio input associated with the user, wherein the first indication of audio input includes a user proposal,
collect, from an information source on the network, risk information about the user,
determine, based on the collected risk information, additional information that, if received from the user, is sufficient to make the user proposal acceptable,
generate a proposal relating to a financial product, wherein the proposal is a counterproposal based on account information associated with the user, the user proposal, and the collected risk information about the user, and wherein the proposal includes a request for the additional information,
send, over the network, information about the proposal,
responsive to sending the information about the proposal, receive, over the network, a second indication of audio input associated with the user including offered information responsive to the request for the additional information,
store the offered information, and
adjust the account information associated with the user to reflect acceptance of the proposal.

9. (canceled)

10. The computing system of claim 8,
wherein the user proposal includes an offer to provide information; and
wherein to generate the proposal the processing circuitry is further configured to identify information that, if received from the user, is sufficient to make the user proposal acceptable.

11. The computing system of claim 8, wherein the financial product is a first financial product, wherein the processing circuitry is further configured to:
generate, based on the offered information, a new proposal associated with a second financial product that is different than the first financial product;
send, over the network, information about the new proposal;
responsive to sending the information about the new proposal, receive, over the network, a third indication of audio input associated with the user;
determine, based on the third indication of audio input, that the user has accepted the new proposal; and
further adjust the account information associated with the user to reflect acceptance of the new proposal.

12. The computing system of claim 8, wherein the user proposal is a first user proposal, and wherein the processing circuitry is further configured to:
receive, over the network, a second user proposal;
determine that the second user proposal is not acceptable;
send, over the network, information indicating that the second user proposal has been denied;
identify, after sending the information indicating that the second user proposal has been denied, changed circumstances relating to the second user proposal;
determine, based on the changed circumstances, that the second user proposal is acceptable;
send, over the network, information requesting further communications relating to the second user proposal;
receive, over the network, an indication of further communications; and
further adjust, based on the indication of further communications, the account information associated with the user to reflect acceptance of the second user proposal.

13. The computing system of claim 8, wherein to receive the first indication of audio input the processing circuitry is further configured to receive a plurality of indications of audio input, wherein the processing circuitry is further configured to:
send, over the network, information responsive to each of the plurality of indications of audio input.

14. The computing system of claim 13, wherein to generate the proposal relating to the financial product the processing circuitry is further configured to generate the proposal based on the plurality of indications of audio input.

15. A computer-readable storage medium comprising instructions that, when executed, configure processing circuitry of a computing system to:
enable an audio monitoring device located within a user's home to perform continual analysis of the user's spoken words;
receive, over a network and from the audio monitoring device, a first indication of audio input associated with the user, wherein the first indication of audio input includes a user proposal,
collect, from an information source on the network, risk information about the user;
determine, based on the collected risk information, additional information that, if received from the user, is sufficient to make the user proposal acceptable;
generate, a proposal relating to a financial product, wherein the proposal is a counterproposal based on account information associated with the user, the user proposal, and the collected risk information about the user, and wherein the proposal includes a request for additional information;
send, over the network, information about the proposal;
responsive to sending the information about the proposal, receive, over the network, a second indication of audio input associated with the user including offered information responsive to the request for the additional information;
store the offered information; and
adjust the account information associated with the user to reflect acceptance of the proposal.

16. (canceled)

17. The computer-readable storage medium of claim 15,
wherein the user proposal includes an offer to provide information; and
wherein the instructions that configure the processing circuitry to generate the proposal include instructions that, when executed, configure the processing circuitry to identify information that, if received from the user, is sufficient to make the user proposal acceptable.

18. The computer-readable storage medium of claim 15, wherein the financial product is a first financial product, wherein the instructions, when executed, further configure the processing circuitry to:
generate, based on the offered information, a new proposal associated with a second financial product that is different than the first financial product;
send, over the network, information about the new proposal;
responsive to sending the information about the new proposal, receive, over the network, a third indication of audio input associated with the user;
determine, based on the third indication of audio input, that the user has accepted the new proposal; and
further adjust the account information associated with the user to reflect acceptance of the new proposal.

19. The computer-readable storage medium of claim 15, wherein the user proposal is a first user proposal, and wherein the instructions, when executed, further configure the processing circuitry to:
receive, over the network, a second user proposal;
determine that the second user proposal is not acceptable;
send, over the network, information indicating that the second user proposal has been denied;
identify, after sending the information indicating that the second user proposal has been denied, changed circumstances relating to the second user proposal;
determine, based on the changed circumstances, that the second user proposal is acceptable;
send, over the network, information requesting further communications relating to the second user proposal;
receive, over the network, an indication of further communications; and
further adjust, based on the indication of further communications, the account information associated with the user to reflect acceptance of the second user proposal.

20. The computer-readable storage medium of claim 15, wherein the instructions that configure the processing circuitry to receive the first indication of audio input include instructions that, when executed, configure the processing circuitry to receive a plurality of indications of audio input, and wherein the instructions, when executed, further configure the processing circuitry to:
send, over the network, information responsive to each of the plurality of indications of audio input.
